(19) United States
(12) Patent Application Publication
(10) Pub. No.: US 2006/0144066 A1
(43) Pub. Date: Jul. 6, 2006

(54) Removable water heating device and refrigerator having the same

(75) Inventors: Myung-ryul Lee, Seongnam-si (KR); Seong-jae Kim, Ansan-si (KR)

Correspondence Address: GREENBLUM & BERNSTEIN, P.L.C., 1950 ROLAND CLARKE PLACE, RESTON, VA, 20191, US

(73) Assignee: LG Electronics Inc, Seoul (KR)

(21) Appl. No.: 11/131,382

(22) Filed: May 18, 2005

(30) Foreign Application Priority Data
Jan. 3, 2005 (KR) 10-2005-0000238

(51) Int. Cl. B67D 5/62; F25B 27/00; F25B 43/04

(52) U.S. Cl. 62/238.6; 62/389; 222/146.1

(57) ABSTRACT

Disclosed are a removable water heating device that can be conveniently replaced in case of leakage of water or breakage of a heating wire for a heater in the water heating device, and a refrigerator having the removable water heating device. The refrigerator having the removable water heating device includes a water supply pipe installed in a door of the refrigerator to supply drinking water from the outside, a water heating device installed in the door to heat a heating pipe installed between a hot-water supply pipe connected to the water supply pipe and a hot-water outlet pipe provided in a dispenser, couplers for coupling the hot-water supply pipe with the hot-water outlet pipe, an installation case configured so that the water heating device can be inserted from the upper side of the door, a cover for closing the installation case, and a through-hole formed in the lower side of the installation case.

### BACKGROUND OF THE INVENTION

1. Field of the Invention

The present invention relates to a removable water heating device which can be conveniently replaced in case of leakage of water or breakage of a heating wire for a heater in the water heating device and a refrigerator having the removable water heating device.

2. Description of the Related Art

In general, as shown in FIG. 1, a refrigerator includes a freezer compartment and a refrigerator compartment which are separated from each other by a partition therebetween. The freezer and refrigerator compartments have their own doors hinged to a main body of the refrigerator so that the doors are allowed to be opened and closed.

The freezer compartment door is provided at its front side with a dispenser for dispensing hot and cold water without the need to open the freezer compartment door. A control panel (not shown) equipped with manipulation buttons is also provided on an upper side of the dispenser.

In a door 10 of the refrigerator, there are installed a water supply pipe 20, a hot-water supply pipe 40 connected between the water supply pipe 20 and a hot-water outlet pipe 31 mounted in a dispenser 30, and a heating unit 50 for heating the hot-water supply pipe 40.

In such a conventional refrigerator, water supplied through the water supply pipe 20 from a water supply flows into the hot-water supply pipe 40 through a switching valve 21 mounted on the water supply pipe 20. Next, the water is instantaneously heated by the heating unit 50 while flowing through the hot-water supply pipe 40. The heated water is discharged through the hot-water outlet pipe 31 mounted in the dispenser 30.

However, in the above-mentioned conventional refrigerator, there has been a problem in that since the heating unit installed in the door is enclosed by foam, the whole door should be replaced in case of leakage of water from the hot-water supply pipe or breakage of a heating wire for the heating unit.

### SUMMARY OF THE INVENTION

The present invention has been made in view of the above problems. Therefore, it is an object of the present invention to provide a removable water heating device that can be conveniently replaced in case of leakage of water or breakage of a heating wire for a heater in the water heating device.

It is another object of the present invention to provide a removable water heating device configured so that the water pressure of a water supply can be easily adjusted from the outside.

In accordance with an aspect of the present invention, there is provided a removable water heating device comprising: a heating pipe including coupling parts coupled with a hot-water supply pipe and a hot-water outlet pipe; and a heater for heating the heating pipe to supply hot water.

The removable water heating device may further comprise a decompression valve provided on the heating pipe.

The removable water heating device may further comprise a valve adjustor connected to the decompression valve so that water pressure can be manually adjusted.

Both ends of the heating pipe may be air-tightly coupled by couplers with the hot-water supply pipe and the hot-water outlet pipe, respectively.

In accordance with another aspect of the present invention, there is provided a refrigerator comprising: a water supply pipe installed in a door of the refrigerator; and a water heating device provided between a hot-water supply pipe connected to the water supply pipe and a hot-water outlet pipe to heat water and supply the heated water, wherein the water heating device is detachably installed in an installation case mounted in the door.

The refrigerator may further comprise a switching valve provided in the water supply pipe and connected to the hot-water supply pipe and a cold-water supply pipe.

The water heating device may comprise: a heating pipe installed between the hot-water supply pipe and the hot-water outlet pipe; and a heater for heating the heating pipe.

The refrigerator may further comprise: a temperature sensor for detecting temperature of water flowing in the heating pipe; and a controller for controlling the heater based on the detected temperature.

The heater may be a sheath heater, a PTC heater, a wire heater, or a pad heater.

The heating pipe may be provided to have a repeated U-shaped pattern where each turn is spaced apart from its neighbors.

The refrigerator may further comprise a decompression valve provided in the heating pipe to adjust the water pressure of the supplied water.

The installation case may be a hollow rectangular case and be installed in the refrigerator door such that its upper side is level with the upper side of the refrigerator door.

The installation case may be opened at its upper side, and a cover may be provided to close the upper side of the installation case.

A valve adjustor for adjusting a decompression valve may be exposed on the upper side of the cover through a hole formed through the cover.

A valve adjustor for adjusting a decompression valve may be installed on the lower side of the cover.

Both coupling parts of a heating pipe may be inserted through through-holes and air-tightly coupled by couplers with the hot-water supply pipe and the hot-water outlet pipe.

The refrigerator may further comprise guide pins for spacing the water heating device and an inner surface of the installation case apart from each other.

The installation case may be installed in the refrigerator door and fixed to the refrigerator door by foam formed between an outer surface of the installation case and an inner surface of the refrigerator door.

The refrigerator may further comprise: a water supply valve provided in the hot-water outlet pipe; and an open/close valve provided in the hot-water supply pipe.

The water supply valve and the open/close valve may be simultaneously opened when hot water is discharged.

### BRIEF DESCRIPTION OF THE DRAWINGS

The present invention will become more apparent by describing in detail exemplary embodiments thereof with reference to the attached drawings in which:

FIG. 1 is a front elevation of a conventional refrigerator;

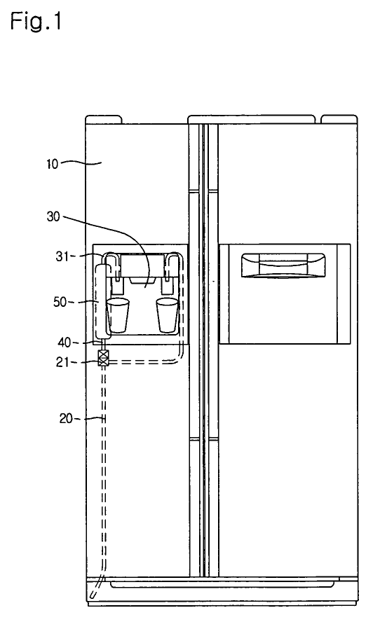

FIG. 2 is a front elevation of a refrigerator having a water heating device according to a preferred embodiment of the present invention;

FIG. 3 is a partially exploded perspective view of a refrigerator having a water heating device according to a preferred embodiment of the present invention; and

FIG. 4 is a partially perspective view of the refrigerator shown in FIG. 3.

### DESCRIPTION OF THE PREFERRED EMBODIMENTS

Exemplary embodiments of the present invention will be described in detail with reference to the accompanying drawings wherein like reference numerals designate like elements.

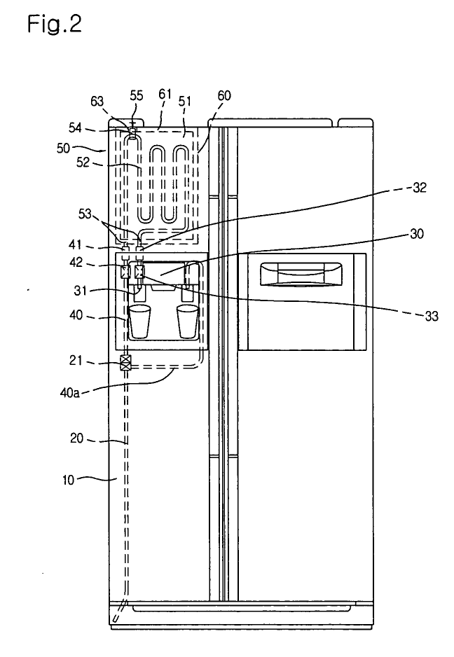

FIG. 2 shows a removable water heating device according to the present invention and a refrigerator having the water heating device, where a water supply pipe 20 installed in a door 10 of the refrigerator is connected to an external water supply and has a water filter mounted thereon so that clean water can be supplied to the refrigerator through the water filter. In addition, the water supply pipe 20 is provided with a switching valve 21 which is connected to a hot-water supply pipe 40 and a cold-water supply pipe 40a. The cold-water supply pipe 40a is connected to a cold-water outlet pipe of a dispenser 30 to supply cold water. The hot-water supply pipe 40 is connected to a hot-water outlet pipe 31 of the dispenser 30 through a water heating device 51 installed between the hot-water supply pipe 40 and the hot-water outlet pipe 31. A user can discharge through the hot-water outlet pipe 31 water which is supplied through the hot-water supply pipe 40 from the water supply and is in turn heated by the water heating device 51.

A water supply valve 33 and an open/close valve 42 are mounted on the hot-water outlet pipe 31 and the hot-water supply pipe 40, respectively, such that they operate together. That is, when a user discharges hot water through the dispenser 30, the water supply valve 33 is opened and at the same time the open/close valve 42 is also opened, thereby preventing the water heating device 51 from heating water unnecessarily.

The water heating device 51 is inserted from an upper side of the refrigerator door 10 into a hollow installation case 60 installed in the door 10. A heating pipe 52 provided in the water heating device 51 has a decompression valve 54 mounted thereon for adjusting the water pressure of the water supplied from a water supply. The heating pipe 52 is air-tightly coupled by couplers 41 and 32 with the hot-water supply pipe 40 and the hot-water outlet pipe 31. In more detail, the heating pipe 52 has coupling parts 53 on its both ends, and the coupling parts 53 are inserted through through-holes 62 formed in the lower side of the installation case 60 and then air-tightly coupled by the couplers 41 and 32 with the hot-water supply pipe 40 and the hot-water outlet pipe 31. The heating pipe 52 may be provided to have a repeated U-shaped pattern where each turn is spaced apart from its neighbors.

The installation case 60 is placed in the refrigerator door 10 and fixed therein by foam. The installation case 60 has an empty space therein to accommodate the detachable water heating device 51. The installation case 60 is ceramic coated on its inner surface to prevent its corrosion and to improve its heat resistance, while the installation case 60 is coated on its outer surface with an insulating material such as glass fiber or synthetic resin to prevent heat emission. In addition, the installation case 60 is provided on its inner surface with guide pins for spacing the water heating device 51 and the wall surface of the refrigerator door 10 apart from each other so that heat generated from a heater in the water heating device cannot be transmitted through the refrigerator door 10 to the inside of the refrigerator.

The installation case 60 is opened at its upper side. A cover 61 is provided to close the upper side of the installation case 60. A valve adjustor 55 for the decompression valve 54 mounted on the heating pipe 52 is provided to be exposed out of a hole 63 formed through the cover 61 so that it can be conveniently handled by a user.

Alternatively, the valve adjustor 55 may be provided not to be exposed to the outside. In this case, the valve adjustor 55 can be adjusted after the cover 61 is opened.

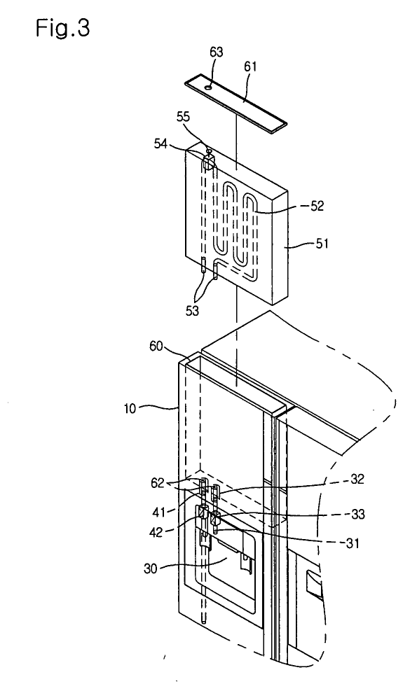

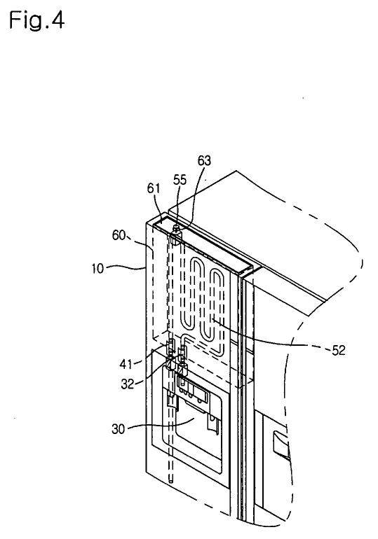

FIG. 3 is a partially exploded perspective view of a refrigerator having a water heating device according to a preferred embodiment of the present invention. FIG. 4 is a partially perspective view of the refrigerator shown in FIG. 3. As shown in FIGS. 3 and 4, the installation case 60 is placed in the refrigerator door 10 and fixed to the refrigerator door 10 by foam formed between the inner surface of the refrigerator 10 and the outer surface of the installation case 60. At this time, the installation case 60 is installed in the refrigerator door 10 such that its upper side is level with the upper side of the refrigerator door 10. Subsequently, when the water heating device 51 is inserted from the upper side of the installation case 60 into the installation case 60, the coupling parts 53 provided on both ends of the heating pipe 52 are inserted through the through-holes 62 into the couplers 41 and 32, whereby the hot-water supply pipe 40 and the hot-water outlet pipe 31 are air-tightly coupled with the heating pipe 52 mounted in the water heating device 51.

Moreover, the valve adjustor 55 for the decompression valve 54, which is mounted on the heating pipe 52 and exposed on the upper side of the water heating device 51, is exposed on the upper side of the door 10 through the hole 63 formed through the cover 61 for closing the upper side of the installation case 60. The cover 61 is fixed to the installation case 60 by fixing pieces or the like. Since the valve adjustor 55 is exposed through the hole 63 to the outside, a user or an operator can easily control the decompression valve 54 according to the water pressure of the water supply.

In addition, on the heating pipe 52, there may be further provided a temperature sensor (not shown) for detecting water temperature and a controller (not shown) for controlling the heater based on the detected water temperature so that water can be heated to a desired temperature while circulating through the heating pipe 52 and then can be supplied through the dispenser 30 to a user.

When the user discharges hot water through the dispenser 30, the water supply valve 33 mounted on the hot-water outlet pipe 31 and the open/close valve 42 mounted on the hot-water supply pipe 40 are simultaneously opened, thus preventing the water heating device 51 from heating water unnecessarily when the water supplied to the heating pipe 52 through the hot-water supply pipe 40 is not discharged.

The water heating device 51 is responsible for heating water circulating through the heating pipe 52 by means of the heater mounted in the water heating device 51. Examples of the heater include a sheath heater, a positive temperature coefficient (PTC) heater, a wire heater, a pad heater, and the like.

As apparent from the above description, the present invention provides a removable water heating device that can be conveniently replaced in case of leakage of water or breakage of a heating wire for a heater in the water heating device. Accordingly, it is convenient to maintain and troubleshoot the water heating device and the refrigerator having the water heating device in case of leakage of water or breakage of a heating wire for a heater in the water heating device since it is not necessary to replace the whole refrigerator door.

Further, according to the present invention, the water pressure of a water supply can be conveniently controlled from the outside, and unnecessary heating of water is prevented when hot water is not discharged.

While the present invention has been described with reference to exemplary embodiments thereof, it will be understood by those skilled in the art that various changes in form and details may be made therein without departing from the scope of the present invention as defined by the following claims.

What is claimed is:

1. A removable water heating device comprising:
a heating pipe including coupling parts coupled with a hot-water supply pipe and a hot-water outlet pipe; and
a heater for heating the heating pipe to supply hot water.

2. The removable water heating device of claim 1, further comprising a decompression valve provided on the heating pipe.

3. The removable water heating device of claim 2, further comprising a valve adjustor connected to the decompression valve so that water pressure can be manually adjusted.

4. The removable water heating device of claims 1, wherein both ends of the heating pipe are air-tightly coupled by couplers with the hot-water supply pipe and the hot-water outlet pipe, respectively.

5. A refrigerator comprising:
a water supply pipe installed in a door of the refrigerator; and
a water heating device provided between a hot-water supply pipe connected to the water supply pipe and a hot-water outlet pipe to heat water and supply the heated water,
wherein the water heating device is detachably installed in an installation case mounted in the door.

6. The refrigerator of claim 5, further comprising a switching valve provided in the water supply pipe and connected to the hot-water supply pipe and a cold-water supply pipe.

7. The refrigerator of claim 5, wherein the water heating device comprises:
a heating pipe installed between the hot-water supply pipe and the hot-water outlet pipe; and
a heater for heating the heating pipe.

8. The refrigerator of claim 7, further comprising:
a temperature sensor for detecting temperature of water flowing in the heating pipe; and
a controller for controlling the heater based on the detected temperature.

9. The refrigerator of claim 8, wherein the heater is a sheath heater, a PTC (positive temperature coefficient) heater, a wire heater, or a pad heater.

10. The refrigerator of claim 7, wherein the heating pipe is provided to have a repeated U-shaped pattern where each turn is spaced apart from its neighbors.

11. The refrigerator of claim 7, further comprising a decompression valve provided in the heating pipe to adjust the water pressure of the supplied water.

12. The refrigerator of claim 5, wherein the installation case is a hollow rectangular case and is installed in the refrigerator door such that its upper side is level with the upper side of the refrigerator door.

13. The refrigerator of claim 12, wherein the installation case is opened at its upper side, and a cover is provided to close the upper side of the installation case.

14. The refrigerator of claim 13, wherein a valve adjustor for adjusting a decompression valve is exposed on the upper side of the cover through a hole formed through the cover.

15. The refrigerator of claim 13, wherein a valve adjustor for adjusting a decompression valve is installed on the lower side of the cover.

16. The refrigerator of claim 12, wherein both coupling parts of a heating pipe are inserted through through-holes and air-tightly coupled by couplers with the hot-water supply pipe and the hot-water outlet pipe.

17. The refrigerator of claim 12, further comprising guide pins for spacing the water heating device and an inner surface of the installation case apart from each other.

18. The refrigerator of claim 12, wherein the installation case is installed in the refrigerator door and fixed to the refrigerator door by foam formed between an outer surface of the installation case and an inner surface of the refrigerator door.

19. The refrigerator of claim 5, further comprising:
a water supply valve provided in the hot-water outlet pipe; and
an open/close valve provided in the hot-water supply pipe.

20. The refrigerator of claim 19, wherein the water supply valve and the open/close valve are simultaneously opened when hot water is discharged.
